(19) United States
(12) Patent Application Publication
(10) Pub. No.: US 2012/0323601 A1
(43) Pub. Date: Dec. 20, 2012

(54) DISTRIBUTED SHARING OF ELECTRONIC MEDICAL RECORDS

(75) Inventors: Yanlin Huang, Beijing (CN); Bing Wu, Beijing (CN); Ricky Sun, Beijing (CN)

(73) Assignee: MICROSOFT CORPORATION, Redmond, WA (US)

(21) Appl. No.: 13/159,421

(22) Filed: Jun. 14, 2011

(51) Int. Cl. G06Q 50/00; G06Q 10/00

(52) U.S. Cl. 705/3

(57) ABSTRACT

A summary request including a patient identifier may be obtained from a network client requesting location indications associated with medical facility locations associated with storage of detail patient data associated with a patient. If an index patient indicator associated with the patient identifier is included in an aggregation facility index associated with an aggregation facility repository that includes summary patient data associated with a plurality of medical facilities and a plurality of patients, summary patient data that summarizes medical events associated with the patient identifier may be obtained, based on information included in the aggregation facility index, and a summary data response that includes the summary patient data and location indications associated with medical facility locations associated with storage of detail patient data associated with the summary patient data may be transmitted to the network client; otherwise, the summary request may be forwarded to a hierarchically superior facility aggregation service.

### BACKGROUND

In the rapidly advancing electronic age, many previously paper-based systems of maintaining records such as patient records have been automated to provide electronic records such as electronic medical records (EMRs). For example, a hospital or other medical facility may employ information technology specialists to write program code to receive and store patient data for later retrieval. Each different medical facility may have its own preferences for formatting the records. For example, one hospital may decide that emergency room patient data may be listed first on a patient history form, while another medical facility may decide that ongoing diseases such as cancer or heart disease may be listed prominently on all forms of the affected patients. Moreover, the information technology specialists hired to automate the medical records may apply their own individual choices for internal formatting of the patient data.

If a patient has been treated at several different medical facilities, the patient data at each facility may be stored in a different format, so that if a medical specialist requests the information, he/she may be asked to fax a request for information, and may be asked further to wait for delivery of the information, either via fax, email scan, or via a delivery person.

### SUMMARY

According to one general aspect, a distributed patient data retrieval engine may include a request input engine configured to obtain a summary request sent from a network client for one or more location indications associated with one or more medical facility locations associated with storage of detail patient data associated with a patient, the summary request including a patient identifier associated with the patient. The distributed patient data retrieval engine may also include an index matching engine configured to determine, via a data query processor, whether an index patient indicator associated with the patient identifier is included in an aggregation facility index associated with an aggregation facility repository that includes summary patient data associated with a plurality of medical facilities and a plurality of patients. The distributed patient data retrieval engine may also include a summary retrieval engine configured to obtain summary patient data that summarizes medical events associated with the patient identifier, based on information included in the aggregation facility index, if the index matching engine determines that the index patient indicator associated with the patient identifier is included in the aggregation facility index. The distributed patient data retrieval engine may also include a response interface engine configured to initiate transmission to the network client of a summary data response that includes the summary patient data and one or more location indications associated with one or more medical facility locations associated with storage of detail patient data associated with the summary patient data, if the index matching engine determines that the index patient indicator associated with the patient identifier is included in the aggregation facility index. The distributed patient data retrieval engine may also include a superior service interface engine configured to forward the summary request to a hierarchically superior facility aggregation service, if the index matching engine determines that the index patient indicator associated with the patient identifier is absent from the aggregation facility index.

According to another aspect, a computer program product tangibly embodied on a computer-readable medium may include executable code that, when executed, is configured to cause at least one data processing apparatus to receive a client request for detail patient data associated with one or more patient records associated with a patient, and initiate transmission, via a client processor, of a summary request to a facility aggregation service for one or more location indications associated with one or more medical facility locations associated with storage of the requested detail patient data. Further, the data processing apparatus may receive summary patient data that includes the one or more location indications, in response to the summary request, and initiate transmission of at least one data request for the detail patient data to at least one facility data service associated with at least one of the location indications. Further, the data processing apparatus may receive the requested detail patient data from the at least one facility data service, and initiate a display of the received detail patient data.

According to another aspect, a computer program product tangibly embodied on a computer-readable medium may include executable code that, when executed, is configured to cause at least one data processing apparatus to obtain detail patient data associated with a patient, the detail patient data sent from a medical facility database interface, and obtain summary patient data that summarizes medical events associated with the patient, based on the detail patient data. Further, the data processing apparatus may initiate, via a data management processor, a patient data synchronization event with a facility aggregation service based on the summary patient data, and receive a data request for the detail patient data, the data request associated with a network client requestor. Further, the data processing apparatus may initiate transmission of the detail patient data to the network client requestor.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### DRAWINGS

FIG. 1 is a block diagram of a system for retrieval of distributed patient data.

FIG. 2 is a block diagram of a system for client retrieval of distributed patient data.

FIG. 3 is a block diagram of a system for medical facility retrieval of distributed patient data.

FIGS. 4a-4c are a flowchart illustrating example operations of the system of FIG. 1.

FIGS. 5a-5c are a flowchart illustrating example operations of the system of FIG. 2.

FIG. 6 is a flowchart illustrating example operations of the system of FIG. 3.

FIG. 7 depicts an example user view of a display of an electronic medical record in accordance with the example system of FIGS. 1-3 for retrieval of distributed patient data.

FIG. 8 is a block diagram of an example system for retrieval of distributed patient data.

FIG. 9 is a block diagram of an example system for retrieval of distributed patient data.

### DETAILED DESCRIPTION

In an environment of automated records, a medical specialist may access records more quickly than waiting for a paper file to be retrieved from a file room (and may also save time of waiting while a file clerk searches for an improperly filed, or lost, folder). The medical specialist may quickly and efficiently access many items offered by many different vendors online, such as via office product catalogs, medical apparel outlets, and prescription drug outlets. He/she may enter a search term for a particular item, and may quickly receive a listing of the item with prices retrieved from several different vendors for comparison shopping. As another example, there are many different services available online for comparing prices of airplane flights.

He/she may also quickly access information regarding themselves or other people via social networking sites. However, he/she may be unable to quickly access vital patient information from multiple sources via an online session.

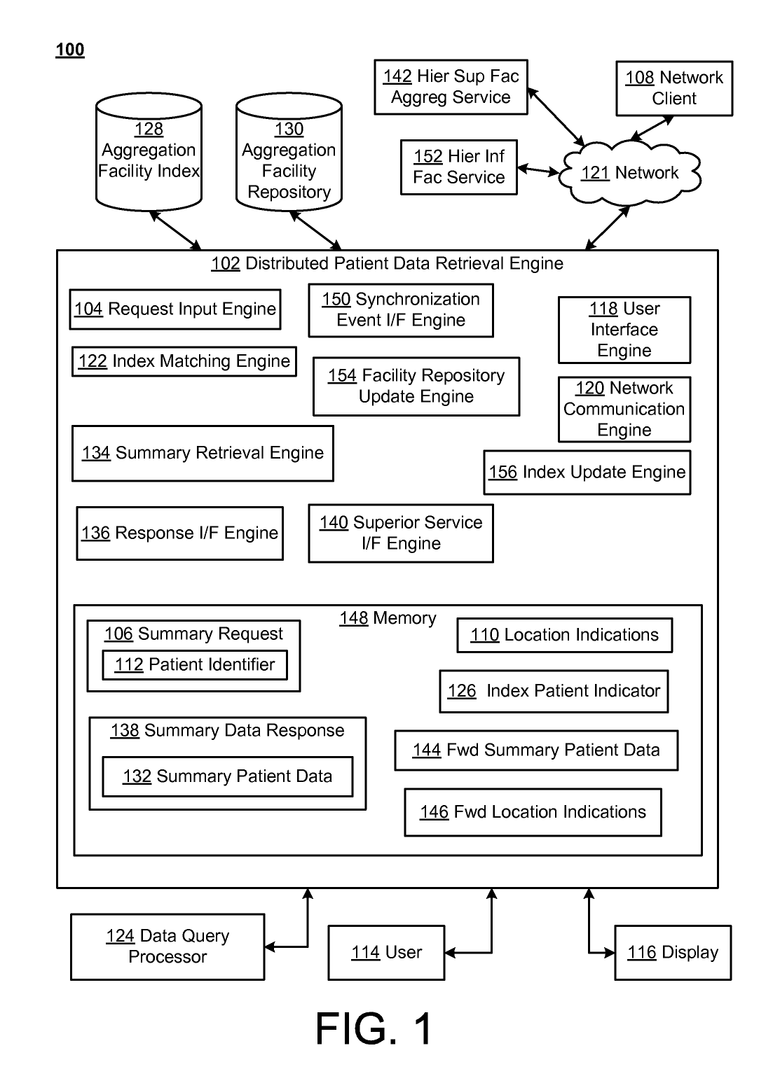

As further discussed herein, FIG. 1 is a block diagram of a system 100 for retrieval of distributed patient data. As shown in FIG. 1, a system 100 may include a distributed patient data retrieval engine 102 that includes a request input engine 104 that may be configured to obtain a summary request 106 sent from a network client 108 for one or more location indications 110 associated with one or more medical facility locations associated with storage of detail patient data associated with a patient, the summary request 106 including a patient identifier 112 associated with the patient. For example, the network client 108 may include a user such as a physician who may be seeking medical history information associated with the patient. For example, the patient (e.g., John Doe) may have indicated to the physician that the patient has received trauma treatment at several different medical facilities across the United States. The physician may enter identifying information as the patient identifier 112 (e.g., patient name, birth date, social security number, passport number) at the network client 108 device.

A user 114 (e.g., a system administrator) may access the system 100 and may view system information via a display 116. For example, the display 116 may provide a visual, audio, and/or tactile medium for the user 114 to monitor his/her input to and responses from the distributed patient data retrieval engine 102. For example, the user 114 may provide input via a touchpad, a touchscreen, a keyboard or keypad, a mouse device, a trackball device, or an audio input device or other input sensing device. For example, the user 114 may speak information for voice recognition processing to character format.

A user interface engine 118 may be configured to manage communications between the user 114 and the distributed patient data retrieval engine 102. A network communication engine 120 may be configured to manage network communication between the distributed patient data retrieval engine 102 and other entities that may communicate with the distributed patient data retrieval engine 102 via one or more networks 121.

An index matching engine 122 may be configured to determine, via a data query processor 124, whether an index patient indicator 126 associated with the patient identifier 112 is included in an aggregation facility index 128 associated with an aggregation facility repository 130 that includes summary patient data 132 associated with a plurality of medical facilities and a plurality of patients.

For example, the aggregation facility repository 130 may include summary patient data 132 such as dates of medical treatment, names of patient, and names of medical facilities where treatment may been rendered. For example, the aggregation facility index 128 may include information identifying the patient associated with summary patient data (e.g., name, identification numbers, birth date), and information indicating a location for retrieving the summary patient data 132 associated with the patient identifier 112. For example, the summary patient data 132 may include summary information regarding patient treatment, as well information indicating a means for locating detailed patient information associated with the summary patient data 132 (e.g., an Internet address for a medical facility service hosting the detail associated with the summary patient data 132).

In this context, a “processor” may include a single processor or multiple processors configured to process instructions associated with a processing system. A processor may thus include multiple processors processing instructions in parallel and/or in a distributed manner.

A summary retrieval engine 134 may be configured to obtain summary patient data 132 that summarizes medical events associated with the patient identifier 112, based on information included in the aggregation facility index 128, if the index matching engine 122 determines that the index patient indicator 126 associated with the patient identifier 112 is included in the aggregation facility index 128. For example, if there are multiple patients matching the patient identifier 112, then potentially all of the summary data for the multiple patients may be included in the obtained summary patient data 132. For example, a recipient may then view the summary data to determine which data is relevant to a patient under consideration for treatment or review.

A response interface engine 136 may be configured to initiate transmission to the network client 108 of a summary data response 138 that includes the summary patient data 132 and one or more location indications 110 associated with one or more medical facility locations associated with storage of detail patient data associated with the summary patient data 132, if the index matching engine 122 determines that the index patient indicator 126 associated with the patient identifier 112 is included in the aggregation facility index 128. For example, the location indications 110 may provide a recipient with addresses that may be used to request detailed medical information associated with portions of the summary patient data 132 that may be determined to be relevant to a particular patient (e.g., for selection by a physician at the network client 108).

A superior service interface engine 140 may be configured to forward the summary request 106 to a hierarchically superior facility aggregation service 142, if the index matching engine 122 determines that the index patient indicator 126 associated with the patient identifier 112 is absent from the aggregation facility index 128. For example, if the patient identifier 112 has no match in the aggregation facility index 128, then the summary request 106 may be forwarded to an aggregation system that is higher, or superior to, the present aggregation system (e.g., the distributed patient data retrieval engine 102) so that the higher (hierarchically superior) system (e.g., the hierarchically superior facility aggregation service 142) may determine whether the patient identifier 112 matches an index patient indicator 126 in its respective aggregation facility index 128. For example, a regional level aggregation facility may forward the summary request 106 to a provincial level aggregation facility, which may in turn forward the summary request 106 to a national level aggregation facility, until a match is found.

According to an example embodiment, the one or more location indications 110 associated with the one or more medical facility locations associated with storage of detail patient data associated with the summary patient data 132 may be obtained from the aggregation facility index 128.

According to an example embodiment, the one or more location indications 110 associated with the one or more medical facility locations associated with storage of the requested detail patient data associated with the summary patient data 132 may include one or more Internet addresses associated with the one or more medical facility locations, as discussed further below.

According to an example embodiment, the superior service interface engine 140 may be configured to receive, from the hierarchically superior facility aggregation service 142, forwarded summary patient data 144 that summarizes medical events associated with the patient, and one or more forwarded location indications 146 associated with one or more medical facility locations associated with storage of detail patient data associated with the forwarded summary patient data 144. For example, if the current aggregation facility (e.g., the distributed patient data retrieval engine 102) determines no match for the patient identifier 112, then the current aggregation facility may receive forwarded summary patient data 144 from a hierarchically superior aggregation facility (e.g., the hierarchically superior facility aggregation service 142) that may find a match in its aggregation facility index 128 for the patient identifier 112.

According to an example embodiment, the response interface engine 136 may be configured to initiate transmission of the forwarded summary patient data 144 and the forwarded location indications 146 to the network client 108, in response to the summary request 106. For example, the current aggregation facility (e.g., the distributed patient data retrieval engine 102) may respond to the network client 108 request, even though the requested summary patient data 144 is not available in the current aggregation facility databases (e.g., by forwarding information received from the hierarchically superior aggregation facility, which may itself obtain the information from a cascading query up a hierarchical structure of aggregation facilities).

According to an example embodiment, a memory 148 may be configured to store the summary request 106 including the patient identifier 112. In this context, a “memory” may include a single memory device or multiple memory devices configured to store data and/or instructions.

According to an example embodiment, the distributed patient data retrieval engine 102 may include a synchronization event interface engine 150 configured to receive the summary patient data 132 that summarizes medical events associated with the patient via a patient data synchronization event associated with a hierarchically inferior facility service 152. According to an example embodiment, a facility repository update engine 154 may be configured to initiate an update to the aggregation facility repository 130, based on the summary patient data 132 received via the synchronization event.

For example, a medical facility such as a hospital may synchronize its detailed patient data with its summary patient data once or twice daily. The summary data at the medical facility level may then be synchronized with summary patient data at the next level up in the hierarchy of aggregation facilities, and on up to the highest level of the hierarchy.

According to an example embodiment, an index update engine 156 may be configured to initiate an update to the aggregation facility index 128 associated with the aggregation facility repository 130, based on the summary patient data 132 received via the synchronization event. According to an example embodiment, the superior service interface engine 140 may be configured to initiate a hierarchy synchronization event with the hierarchically superior facility aggregation service 142 based on the summary patient data 132 received via the patient data synchronization event.

According to an example embodiment, the superior service interface engine 140 may be configured to forward the summary request 106 to the hierarchically superior facility aggregation service 142 based on one of forwarding the summary request 106 from a regional level hierarchical facility aggregation service to a provincial level hierarchical facility aggregation service, forwarding the summary request 106 from a provincial level hierarchical facility aggregation service to a national level hierarchical facility aggregation service, forwarding the summary request 106 from a regional level hierarchical facility aggregation service to a statewide level hierarchical facility aggregation service, or forwarding the summary request 106 from a statewide level hierarchical facility aggregation service to a national level hierarchical facility aggregation service.

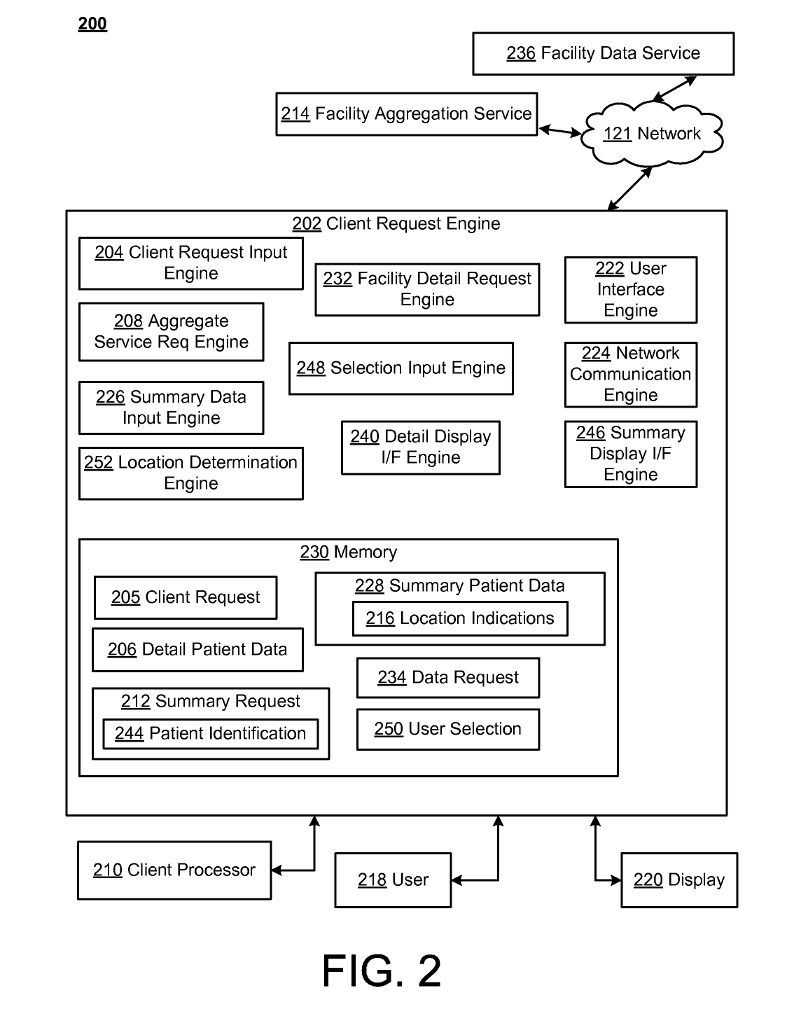

As further discussed herein, FIG. 2 is a block diagram of a system 200 for client retrieval of distributed patient data. As shown in FIG. 2, the system 200 may include a client request engine 202 that may include a client request input engine 204 configured to receive a client request 205 for detail patient data 206 associated with one or more patient records associated with a patient. For example, a physician may request the detail patient data 206 associated with a patient named “John Doe.”

An aggregate service request engine 208 may be configured to initiate transmission, via a client processor 210, of a summary request 212 to a facility aggregation service 214 for one or more location indications 216 associated with one or more medical facility locations associated with storage of the requested detail patient data 206. For example, the request from the physician may be sent to an aggregation facility as a request for summary patient data 228, so that the summary patient data 228 may be analyzed by the physician to select relevant portions for requesting more detailed information, e.g., directly from a relevant medical facility.

A user 218 may access the system 200 and, for example, may view system information via a display 220. For example, the display 220 may provide a visual, audio, and/or tactile medium for the user 218 to monitor his/her input to and responses from the client request engine 202. For example, the user 218 may provide input via a touchpad, a touchscreen, a keyboard or keypad, a mouse device, a trackball device, or an audio input device or other input sensing device. For example, the user 218 may speak information for voice recognition processing to character format.

A user interface engine 222 may be configured to manage communications between the user 218 and the client request engine 202. A network communication engine 224 may be configured to manage network communication between the client request engine 202 and other entities that may communicate with the client request engine 202 via one or more networks 121.

A summary data input engine 226 may be configured to receive summary patient data 228 that includes the one or more location indications 216, in response to the summary request 212. For example, if the physician views a formatted display of the summary patient data 228, he/she may be able to determine which portions of the summary patient data 228 may be relevant to the current situation of the patient. For example, if the physician selects certain portions of the summary patient data 228, then a location indication 216 may immediately provide an address for an electronic query to obtain more detailed medical information related to the selected portions of the summary patient data 228, from a relevant medical facility database, for further investigation by the physician.

According to an example embodiment, a memory 230 may be configured to store the summary patient data 228. In this context, a “memory” may include a single memory device or multiple memory devices configured to store data and/or instructions.

A facility detail request engine 232 may be configured to initiate transmission of at least one data request 234 for the detail patient data 206 to at least one facility data service 236 associated with at least one of the location indications 216.

A detail input engine 238 may be configured to receive the requested detail patient data 206 from the at least one facility data service 236. A detail display interface engine 240 may be configured to initiate a display of the received detail patient data 206.

According to an example embodiment, the detail display interface engine 240 may be configured to initiate the display of the received detail patient data 206 based on initiating the display of the received detail patient data 206 by a browser client, based on a template format associated with the facility aggregation service 214.

According to an example embodiment, the aggregate service request engine 208 may be configured to initiate the transmission of the summary request 212 based on initiating transmission of the summary request 212 to the facility aggregation service 214 by the browser client.

According to an example embodiment, the one or more location indications 216 associated with the one or more medical facility locations associated with storage of the requested detail patient data 206 may include one or more Internet addresses associated with the one or more medical facility locations.

According to an example embodiment, the summary request 212 may include a patient identification 244 associated with the patient, and one or more of an indication of an attribute associated with the requested detail patient data 206, an indication of a requested medical facility associated with the requested detail patient data 206, an indication of a date range associated with the requested detail patient data 206, an indication of a medical event associated with the requested detail patient data 206, an indication of a medical provider identification associated with the requested detail patient data 206, or an indication of a medical treatment associated with the requested detail patient data 206.

According to an example embodiment, the summary request 212 may include a patient identification 244 associated with the patient.

According to an example embodiment, the received summary patient data 228 may include one or more of an indication of a medical event associated with the patient identification 244, an indication of a date of associated with the patient identification 244, an indication of a medical facility associated with the patient identification 244, an indication of a history associated with the patient identification 244, an indication of a patient attribute associated with the patient identification, or an indication of a medical treatment associated with the patient identification 244.

According to an example embodiment, the facility aggregation service 214 may include a hierarchical facility aggregation service.

According to an example embodiment, the aggregate service request engine 208 may be configured to initiate transmission of a second summary request 212 to a second hierarchical facility aggregation service 214 for one or more second location indications 216 associated with one or more medical facility locations associated with storage of the requested detail patient data 206.

According to an example embodiment, the second facility aggregation service may be hierarchically superior to the hierarchical facility aggregation service. According to an example embodiment, a summary display interface engine 246 may be configured to initiate a display of the received summary patient data 228.

According to an example embodiment, a selection input engine 248 may be configured to receive a first indication of a first user selection 250 of a first portion of the summary patient data 228.

According to an example embodiment, a location determination engine 252 may be configured to determine a first selected location indication 216 based on the first indication of the first user selection 250. According to an example embodiment, the facility detail request engine 232 may be configured to initiate transmission of the at least one data request 234 for the detail patient data 206 based on initiating transmission of the at least one data request 234 for detail patient data 206 associated with the first portion of the summary patient data 228 to at least one facility data service 236 associated with the first selected location indication 216.

According to an example embodiment, the selection input engine 248 may be configured to receive a second indication of a second user selection 250 of a second portion of the summary patient data 228.

According to an example embodiment, the location determination engine 252 may be configured to determine a second selected location indication 216 based on the second indication of the second user selection 250, wherein the facility detail request engine 232 may be configured to initiate transmission of the at least one data request 234 for the detail patient data 206 based on initiating transmission of the at least one data request 234 for detail patient data 206 associated with the second portion of the summary patient data 228 to at least one facility data service 236 associated with the second selected location indication 216.

According to an example embodiment, the facility aggregation service 214 may include one of a regional level hierarchical facility aggregation service, a statewide level hierarchical facility aggregation service, a provincial level hierarchical facility aggregation service, or a national level hierarchical facility aggregation service.

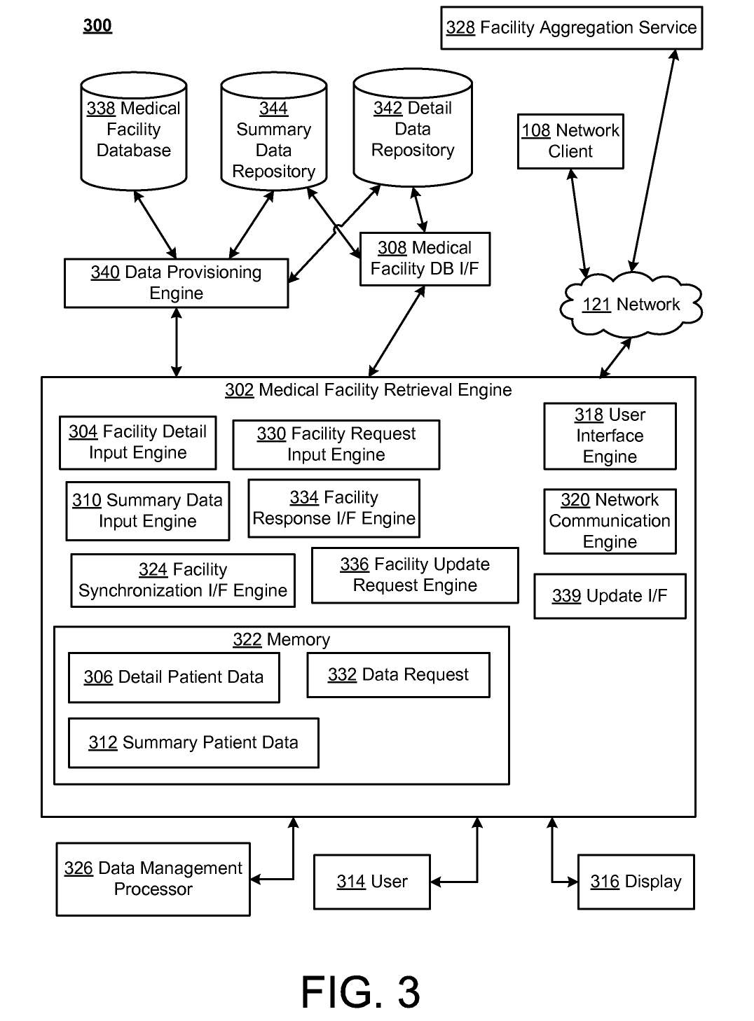

As further discussed herein, FIG. 3 is a block diagram of a system 300 for medical facility retrieval of distributed patient data. As shown in FIG. 3, the system 300 may include a medical facility retrieval engine 302 that includes a facility detail input engine 304 that may be configured to obtain detail patient data 306 associated with a patient, the detail patient data 306 sent from a medical facility database interface 308.

A summary data input engine 310 may be configured to obtain summary patient data 312 that summarizes medical events associated with the patient, based on the detail patient data 306.

A user 314 (e.g., a system administrator) may access the system 300 and may view system information via a display 316. For example, the display 316 may provide a visual, audio, and/or tactile medium for the user 314 to monitor his/her input to and responses from the medical facility retrieval engine 302. For example, the user 314 may provide input via a touchpad, a touchscreen, a keyboard or keypad, a mouse device, a trackball device, or an audio input device or other input sensing device. For example, the user 314 may speak information for voice recognition processing to character format.

A user interface engine 318 may be configured to manage communications between the user 314 and the medical facility retrieval engine 302. A network communication engine 320 may be configured to manage network communication between the medical facility retrieval engine 302 and other entities that may communicate with the medical facility retrieval engine 302 via one or more networks 121.

According to an example embodiment, a memory 322 may be configured to store the summary patient data 312. In this context, a “memory” may include a single memory device or multiple memory devices configured to store data and/or instructions.

A facility synchronization interface engine 324 may be configured to initiate, via a data management processor 326, a patient data synchronization event with a facility aggregation service 328 based on the summary patient data 312.

A facility request input engine 330 may be configured to receive a data request 332 for the detail patient data 306, the data request 332 associated with a network client requestor 108. A facility response interface engine 334 may be configured to initiate transmission of the detail patient data 306 to the network client requestor 108.

According to an example embodiment, a facility update request engine 336 may be configured to initiate an update request for updated detail patient data associated with the patient, the updated patient data stored in a medical facility database 338 in a medical record format that is different from a format associated with the transmitted detail patient data 306. For example, a medical facility may have its detailed patient data stored in its own proprietary formatting that may be associated with the particular medical facility. The data may be converted to a format that is compatible with the aggregation facilities so that virtually any user may be able to view the detailed patient information obtained from a variety of medical facilities, all of whom may store their individual medical records in their own proprietary format, in databases associated with the respective medical facilities.

According to an example embodiment, the facility update request engine 336 may be configured to initiate the update request based on initiating the update request via an update interface 339 configured to initiate communication with a data provisioning engine 340 configured to obtain medical record information from the medical facility database 338 and convert the medical record information to a second format that is compatible with the format associated with the transmitted detail patient data 306. For example, the differently formatted data may be stored as detail data in a detail data repository 342 and as summary data in a summary data repository 344.

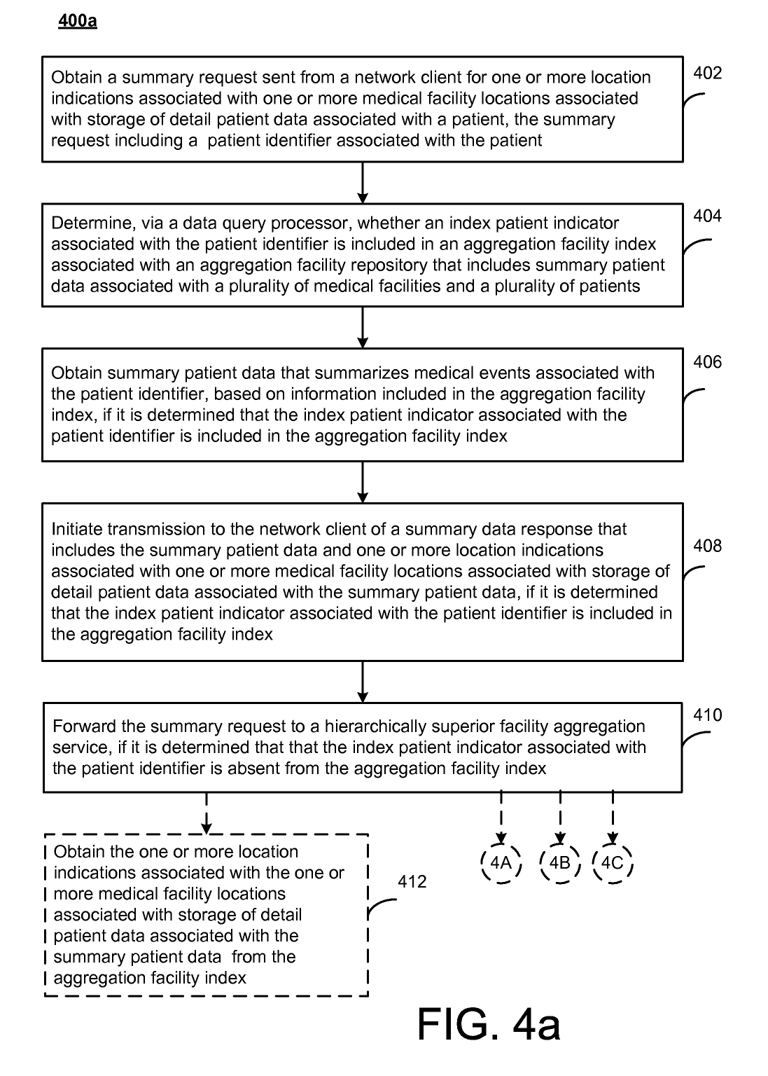

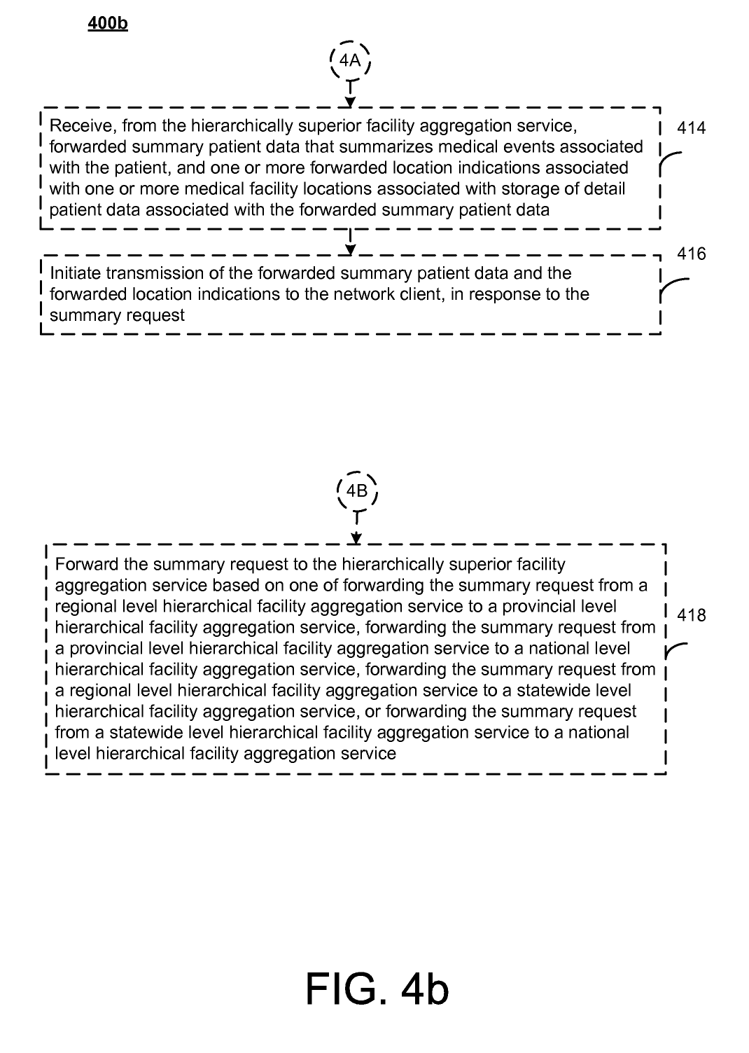

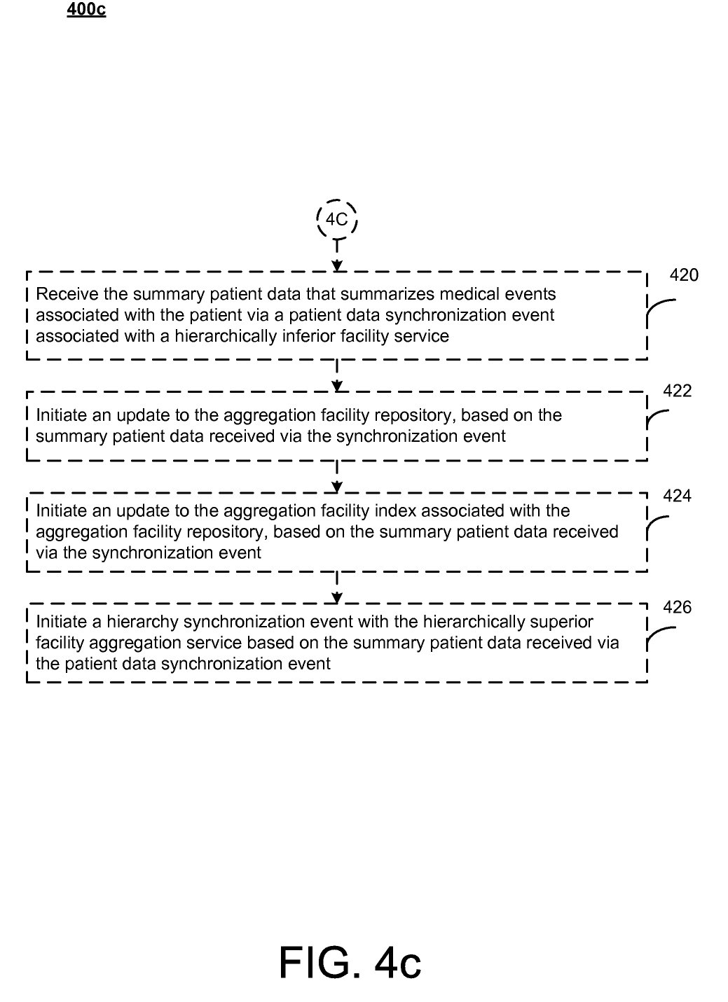

FIGS. 4a-4c are a flowchart 400 illustrating example operations of the system of FIG. 1. In the example of FIG. 4, a summary request sent from a network client for one or more location indications associated with one or more medical facility locations associated with storage of detail patient data associated with a patient, the summary request including a patient identifier associated with the patient may be obtained (402). For example, the request input engine 104 may obtain the summary request 106 sent from the network client 108 for one or more location indications 110 associated with one or more medical facility locations associated with storage of detail patient data associated with the patient, the summary request including the patient identifier 112 associated with the patient, as discussed above.

It may be determined, via a data query processor, whether an index patient indicator associated with the patient identifier is included in an aggregation facility index associated with an aggregation facility repository that includes summary patient data associated with a plurality of medical facilities and a plurality of patients (404). For example, the index matching engine 122 may determine, via the data query processor 124, whether an index patient indicator 126 associated with the patient identifier 112 is included in the aggregation facility index 128 associated with an aggregation facility repository 130 that includes summary patient data 132 associated with a plurality of medical facilities and a plurality of patients, as discussed above.

Summary patient data that summarizes medical events associated with the patient identifier may be obtained, based on information included in the aggregation facility index, if it is determined that the index patient indicator associated with the patient identifier is included in the aggregation facility index (406). For example, the summary retrieval engine 134 may obtain the summary patient data 132 that summarizes medical events associated with the patient identifier 112, based on information included in the aggregation facility index 128, if the index matching engine 122 determines that the index patient indicator 126 associated with the patient identifier 112 is included in the aggregation facility index 128, as discussed above.

Transmission may be initiated to the network client of a summary data response that includes the summary patient data and one or more location indications associated with one or more medical facility locations associated with storage of detail patient data associated with the summary patient data, if it is determined that that the index patient indicator associated with the patient identifier is included in the aggregation facility index (408). For example, the response interface engine 136 may initiate transmission to the network client 108 of a summary data response 138 that includes the summary patient data 132 and one or more location indications 110 associated with one or more medical facility locations associated with storage of detail patient data associated with the summary patient data 132, if the index matching engine 122 determines that the index patient indicator 126 associated with the patient identifier 112 is included in the aggregation facility index 128.

The summary request may be forwarded to a hierarchically superior facility aggregation service, if it is determined that the index patient indicator associated with the patient identifier is absent from the aggregation facility index (410). For example, the superior service interface engine 140 may forward the summary request 106 to the hierarchically superior facility aggregation service 142, if the index matching engine 122 determines that the index patient indicator 126 associated with the patient identifier 112 is absent from the aggregation facility index 128.

According to an example embodiment, the one or more location indications associated with the one or more medical facility locations associated with storage of detail patient data associated with the summary patient data may be obtained from the aggregation facility index (412). According to an example embodiment, the one or more location indications associated with the one or more medical facility locations associated with storage of the requested detail patient data associated with the summary patient data may include one or more Internet addresses associated with the one or more medical facility locations.

According to an example embodiment, forwarded summary patient data that summarizes medical events associated with the patient, and one or more forwarded location indications associated with one or more medical facility locations associated with storage of detail patient data associated with the forwarded summary patient data may be received from the hierarchically superior facility aggregation service (414). For example, the superior service interface engine 140 may receive, from the hierarchically superior facility aggregation service 142, forwarded summary patient data 144 that summarizes medical events associated with the patient, and one or more forwarded location indications 146 associated with one or more medical facility locations associated with storage of detail patient data associated with the forwarded summary patient data 144.

According to an example embodiment, transmission may be initiated of the forwarded summary patient data and the forwarded location indications to the network client, in response to the summary request (416). For example, the response interface engine 136 may initiate transmission of the forwarded summary patient data 144 and the forwarded location indications 146 to the network client 108, in response to the summary request 106.

According to an example embodiment, the summary request may be forwarded to the hierarchically superior facility aggregation service based on one of forwarding the summary request from a regional level hierarchical facility aggregation service to a provincial level hierarchical facility aggregation service, forwarding the summary request from a provincial level hierarchical facility aggregation service to a national level hierarchical facility aggregation service, forwarding the summary request from a regional level hierarchical facility aggregation service to a statewide level hierarchical facility aggregation service, or forwarding the summary request from a statewide level hierarchical facility aggregation service to a national level hierarchical facility aggregation service (418).

According to an example embodiment, the summary patient data that summarizes medical events associated with the patient may be received via a patient data synchronization event associated with a hierarchically inferior facility service (420). For example, the synchronization event interface engine 150 may receive the summary patient data 132 that summarizes medical events associated with the patient via a patient data synchronization event associated with a hierarchically inferior facility service 152.

According to an example embodiment, an update to the aggregation facility repository may be initiated, based on the summary patient data received via the synchronization event (422). For example, the facility repository update engine 154 may initiate an update to the aggregation facility repository 130, based on the summary patient data 132 received via the synchronization event.

According to an example embodiment, an update to the aggregation facility index associated with the aggregation facility repository may be initiated, based on the summary patient data received via the synchronization event (424). For example, the index update engine 156 may initiate an update to the aggregation facility index 128 associated with the aggregation facility repository 130, based on the summary patient data 132 received via the synchronization event.

According to an example embodiment, a hierarchy synchronization event may be initiated with the hierarchically superior facility aggregation service based on the summary patient data received via the patient data synchronization event (426). For example, the superior service interface engine 140 may initiate the hierarchy synchronization event with the hierarchically superior facility aggregation service 142 based on the summary patient data 132 received via the patient data synchronization event.

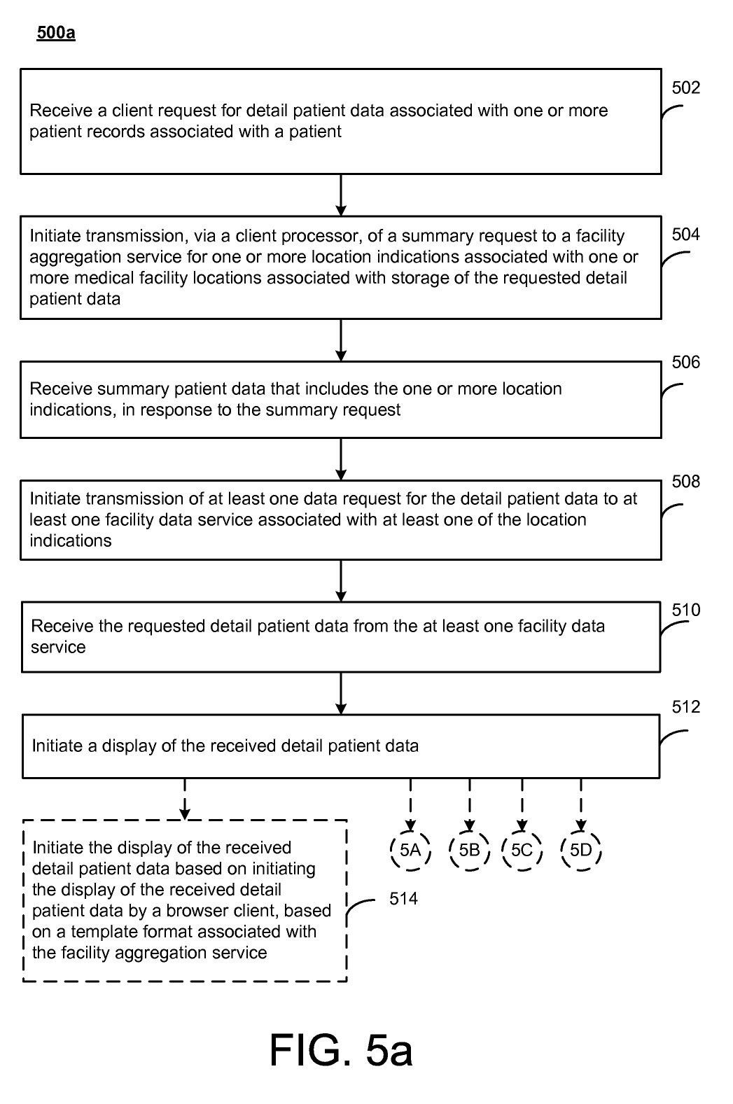

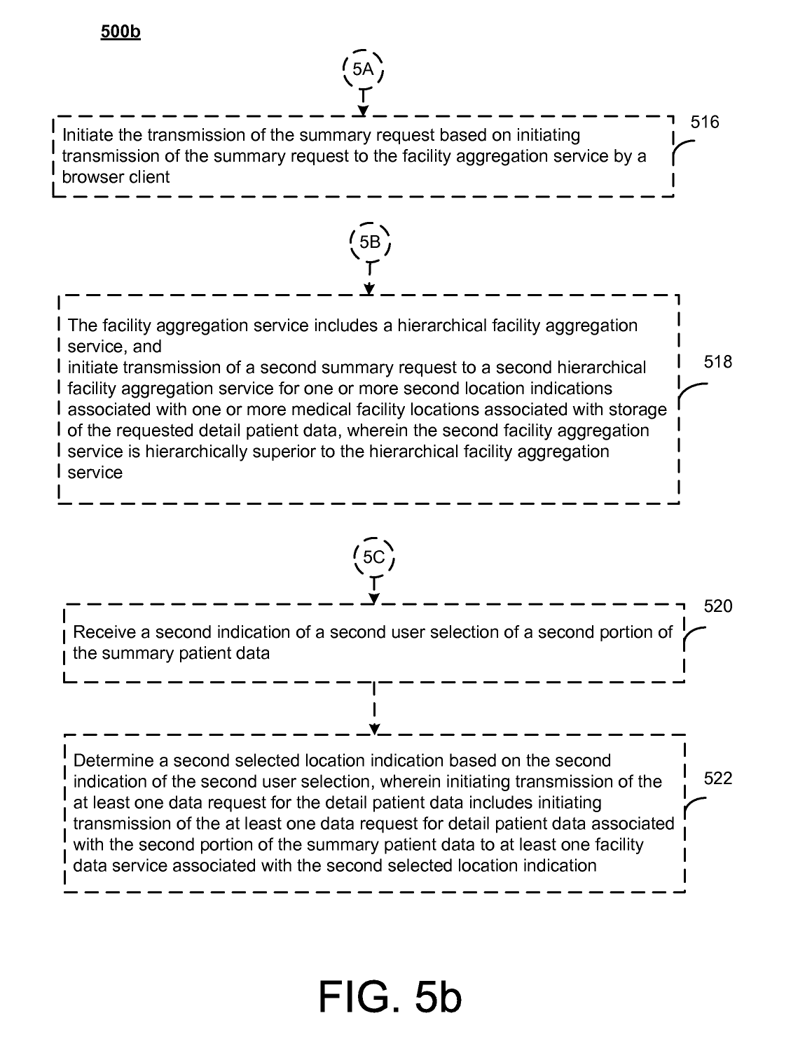

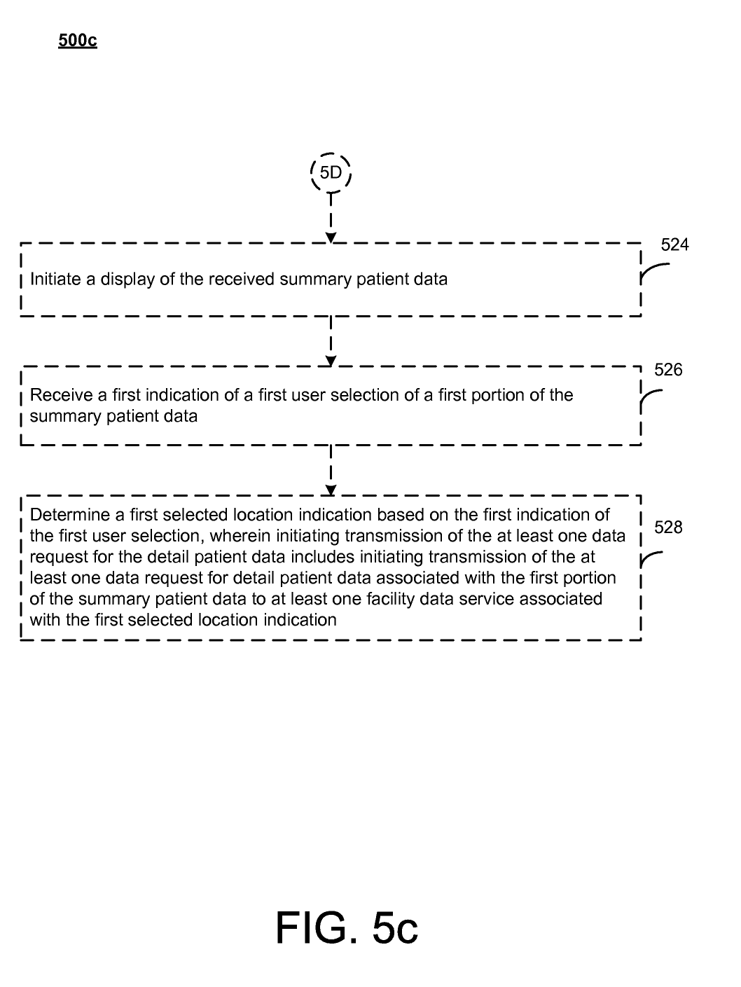

FIGS. 5a-5c are a flowchart 500 illustrating example operations of the system of FIG. 2. In the example of FIG. 5a, a client request for detail patient data associated with one or more patient records associated with a patient may be received (502). For example, the client request input engine 204 may receive the client request for detail patient data 206 associated with one or more patient records associated with a patient.

Transmission may be initiated, via a client processor, of a summary request to a facility aggregation service for one or more location indications associated with one or more medical facility locations associated with storage of the requested detail patient data (504). For example, the aggregate service request engine 208 may initiate transmission, via the client processor 210, of the summary request 212 to a facility aggregation service 214 for one or more location indications 216 associated with one or more medical facility locations associated with storage of the requested detail patient data 206.

Summary patient data that includes the one or more location indications may be received, in response to the summary request (506). For example, the summary data input engine 226 may receive summary patient data 228 that includes the one or more location indications 216, in response to the summary request 212.

Transmission of at least one data request for the detail patient data may be initiated to at least one facility data service associated with at least one of the location indications (508). For example, the facility detail request engine 232 may initiate transmission of at least one data request 234 for the detail patient data 206 to at least one facility data service 236 associated with at least one of the location indications 216.

The requested detail patient data may be received from the at least one facility data service (510). A display of the received detail patient data may be initiated (512). For example, the detail input engine 238 may receive the requested detail patient data 206 from the at least one facility data service 236. The detail display interface engine 240 may initiate a display of the received detail patient data 206.

According to an example embodiment, the display of the received detail patient data may be initiated based on initiating the display of the received detail patient data by a browser client, based on a template format associated with the facility aggregation service (514).

According to an example embodiment, the transmission of the summary request may be initiated based on initiating transmission of the summary request to the facility aggregation service by a browser client (516).

According to an example embodiment, the one or more location indications associated with the one or more medical facility locations associated with storage of the requested detail patient data may include one or more Internet addresses associated with the one or more medical facility locations.

According to an example embodiment, the summary request may include a patient identification associated with the patient, and one or more of an indication of an attribute associated with the requested detail patient data, an indication of a requested medical facility associated with the requested detail patient data, an indication of a date range associated with the requested detail patient data, an indication of a medical event associated with the requested detail patient data, an indication of a medical provider identification associated with the requested detail patient data, or an indication of a medical treatment associated with the requested detail patient data.

According to an example embodiment, the summary request may include a patient identification associated with the patient. According to an example embodiment, the received summary patient data may include one or more of an indication of a medical event associated with the patient identification, an indication of a date of associated with the patient identification, an indication of a medical facility associated with the patient identification, an indication of a history associated with the patient identification, an indication of a patient attribute associated with the patient identification, or an indication of a medical treatment associated with the patient identification.

According to an example embodiment, the facility aggregation service may include a hierarchical facility aggregation service, and transmission of a second summary request to a second hierarchical facility aggregation service for one or more second location indications associated with one or more medical facility locations associated with storage of the requested detail patient data may be initiated, wherein the second facility aggregation service is hierarchically superior to the hierarchical facility aggregation service (518).

According to an example embodiment, a second indication of a second user selection of a second portion of the summary patient data may be received (520).

According to an example embodiment, a second selected location indication may be determined based on the second indication of the second user selection, wherein initiating transmission of the at least one data request for the detail patient data may include initiating transmission of the at least one data request for detail patient data associated with the second portion of the summary patient data to at least one facility data service associated with the second selected location indication (522).

According to an example embodiment, the facility aggregation service may include one of a regional level hierarchical facility aggregation service, a statewide level hierarchical facility aggregation service, a provincial level hierarchical facility aggregation service, or a national level hierarchical facility aggregation service.

According to an example embodiment, a display of the received summary patient data may be initiated (524). According to an example embodiment, a first indication of a first user selection of a first portion of the summary patient data may be received (526). For example, the selection input engine 248 may receive a first indication of a first user selection 250 of a first portion of the summary patient data 228.

According to an example embodiment, a first selected location indication may be determined based on the first indication of the first user selection, wherein initiating transmission of the at least one data request for the detail patient data may include initiating transmission of the at least one data request for detail patient data associated with the first portion of the summary patient data to at least one facility data service associated with the first selected location indication (528). For example, the location determination engine 252 may determine a first selected location indication 216 based on the first indication of the first user selection 250. According to an example embodiment, the facility detail request engine 232 may initiate transmission of the at least one data request 234 for the detail patient data 206 based on initiating transmission of the at least one data request 234 for detail patient data 206 associated with the first portion of the summary patient data 228 to at least one facility data service 236 associated with the first selected location indication 216.

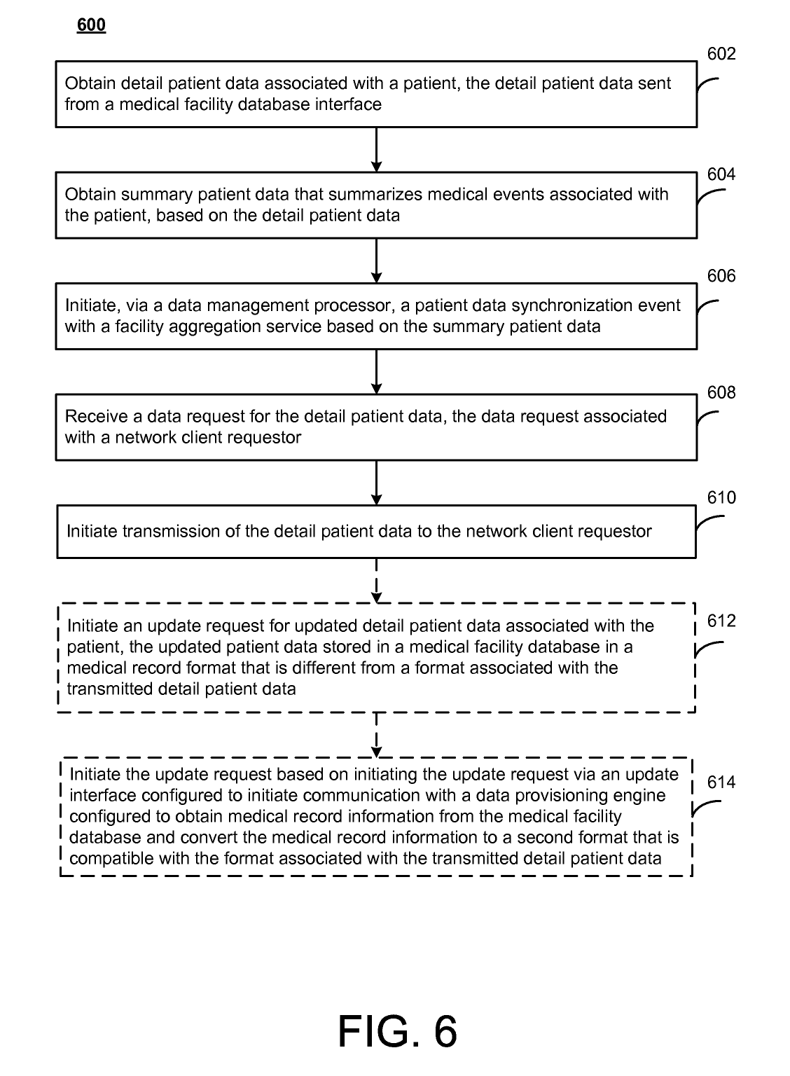

FIG. 6 is a flowchart 600 illustrating example operations of the system of FIG. 3. In the example of FIG. 6, detail patient data associated with a patient, the detail patient data sent from a medical facility database interface may be obtained (602). For example, the facility detail input engine 304 may obtain detail patient data 306 associated with a patient, the detail patient data 306 sent from a medical facility database interface 308.

Summary patient data that summarizes medical events associated with the patient, based on the detail patient data may be obtained (604). For example, the summary data input engine 310 may obtain summary patient data 312 that summarizes medical events associated with the patient, based on the detail patient data 306.

A patient data synchronization event with a facility aggregation service may be initiated, via a data management processor, based on the summary patient data (606). For example, the facility synchronization interface engine 324 may initiate, via the data management processor 326, a patient data synchronization event with a facility aggregation service 328 based on the summary patient data 312.

A data request for the detail patient data may be received, the data request associated with a network client requestor (608). For example, the facility request input engine 330 may receive a data request 332 for the detail patient data 306, the data request 332 associated with a network client requestor 108.

Transmission of the detail patient data to the network client requestor may be initiated (610). For example, the facility response interface engine 334 may initiate transmission of the detail patient data 306 to the network client requestor 108.

According to an example embodiment, an update request for updated detail patient data associated with the patient may be initiated, the updated patient data stored in a medical facility database in a medical record format that is different from a format associated with the transmitted detail patient data (612). For example, the facility update request engine 336 may initiate an update request for updated detail patient data associated with the patient, the updated patient data stored in a medical facility database 338 in a medical record format that is different from a format associated with the transmitted detail patient data 306.

According to an example embodiment, the update request may be initiated based on initiating the update request via an update interface configured to initiate communication with a data provisioning engine configured to obtain medical record information from the medical facility database and convert the medical record information to a second format that is compatible with the format associated with the transmitted detail patient data (614). For example, the facility update request engine 336 may initiate the update request based on initiating the update request via the update interface 339 configured to initiate communication with the data provisioning engine 340 configured to obtain medical record information from the medical facility database 338 and convert the medical record information to a second format that is compatible with the format associated with the transmitted detail patient data 306.

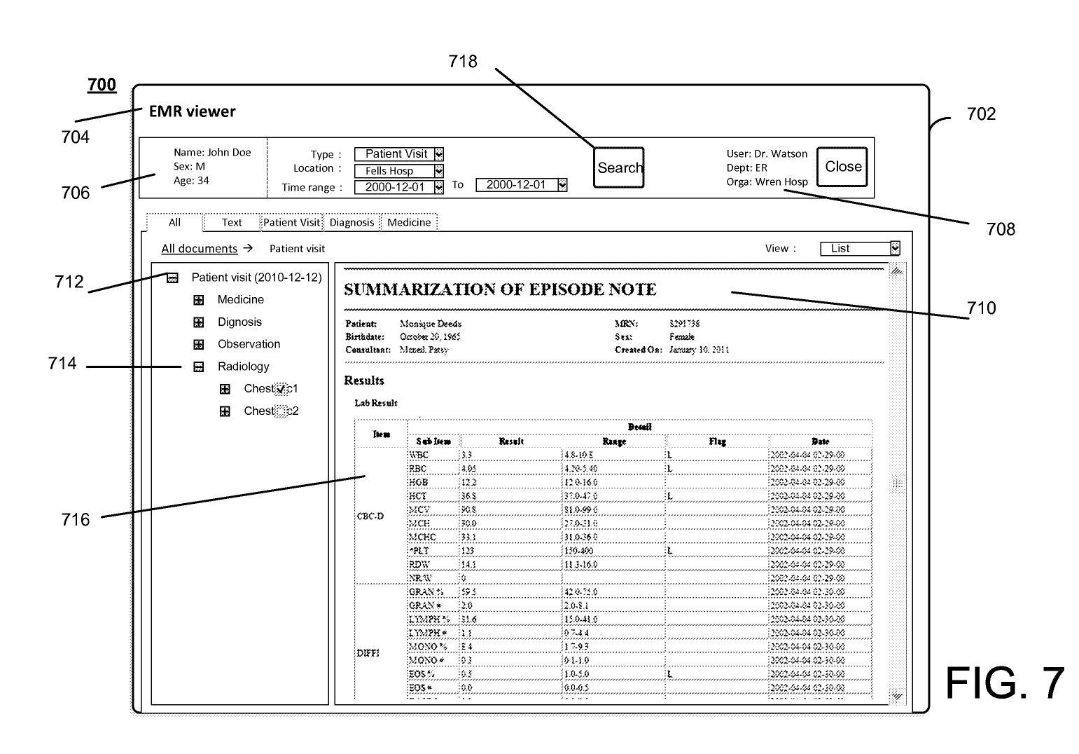

FIG. 7 depicts an example user view 700 of a display of an electronic medical record 702 in accordance with the example system of FIGS. 1-3 for retrieval of distributed patient data. As shown in FIG. 7, a detailed record is displayed, e.g., via the display 220 of the client request engine 202. An EMR Viewer 704 illustrates a display that may be rendered, for example, by a browser client associated with the user 218. As shown in FIG. 7, the detail data includes patient attributes 706 such as a name, gender, and age. Further, the detail data includes user information 708 such as user name, medical facility department, and medical facility name. The detail data as shown indicates a summarization of episode note 710. As shown in FIG. 7, the episode is associated with a patient visit in December of 2010 (712). As indicated further, the episode was associated with radiology testing 714. As shown in FIG. 7, the test results are listed in a detail format 716.

As shown, the display 702 provides text boxes for entering text to initiate a search 718 for other patient data satisfying the entered search criteria. For example, the search criteria may include a type of medical event (e.g., patient visit), a location of the medical event (e.g., a specific hospital), and a date range.

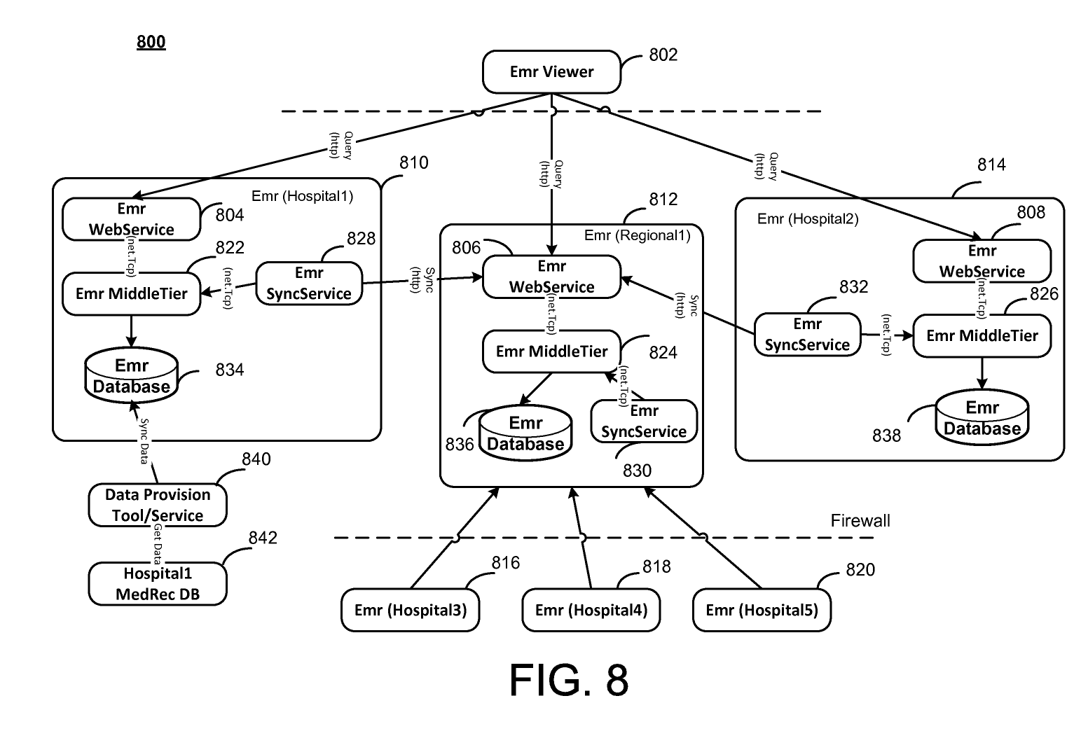

FIG. 8 is a block diagram of an example system 800 for retrieval of distributed patient data. As shown in FIG. 8, an EMR viewer 802 (e.g., the EMR Viewer 704 discussed above) may communicate with example EMR WebServices 804, 806, and 808 that may be included in EMR systems associated with a first hospital (810), a regional aggregation service (812), and a second hospital (814), respectively.

As shown in FIG. 8, the aggregation service 812 may be associated with, and may host summary medical data for, the first and second hospitals, and for a third, fourth and fifth hospital (816, 818, 820, respectively).

As shown in FIG. 8, the EMR Viewer 802 may query the EMR Webservices 804, 806, and 808 via (secure) Hypertext Transfer Protocol (http) connections. Each of the facilities 810, 812, 814 may include a reusable, scalable structure that includes the EMR Webservice (804, 806, 808, respectively), an EMR Middle Tier (822, 824, 826, respectively), an EMR SyncService (828, 830, 832, respectively), and an EMR database (834, 836, 838, respectively).

As shown in FIG. 8, the first hospital service includes a data provision tool/service 840 and a MedRec database 842.

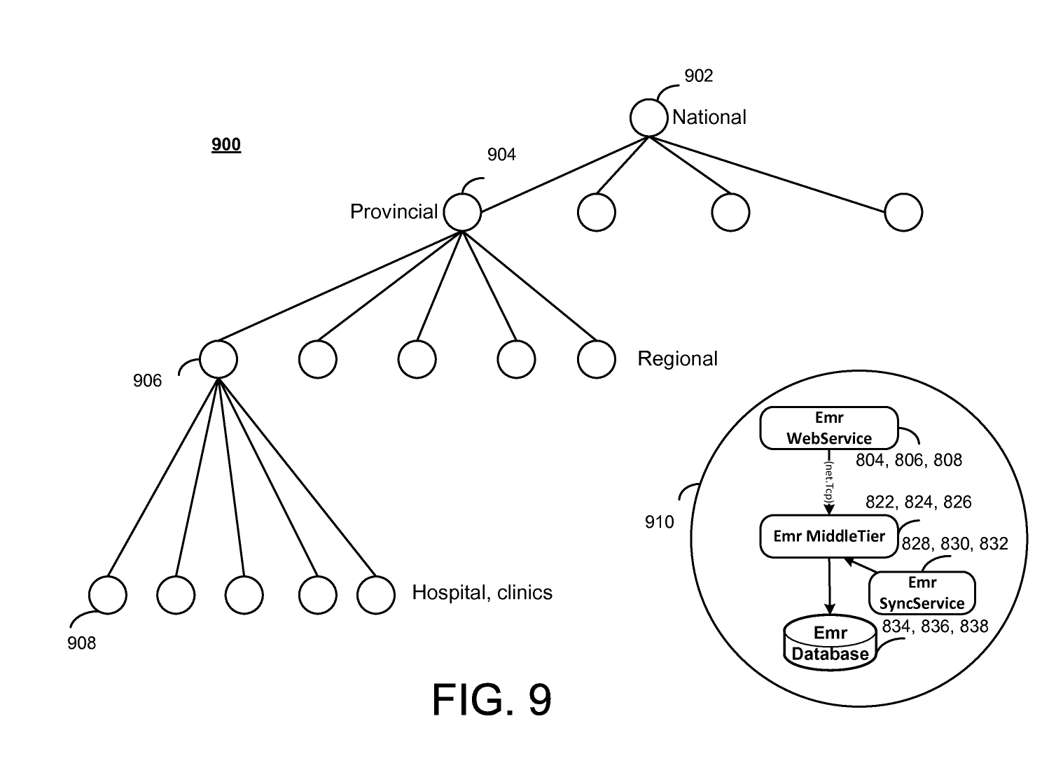

FIG. 9 is a block diagram of an example system 900 for retrieval of distributed patient data. As shown in FIG. 9, a hierarchical structure 900 may include hierarchically arranged aggregated services 902, 904, 906, and 908 (e.g., aggregated services that may include the distributed patient data retrieval engine 102 discussed above in detail). For example, the aggregated service 902 may be configured at a medical facility level 908 (e.g., hospitals, clinics, as shown in FIG. 3), or at a hierarchically superior level 910 (e.g., a regional or state level aggregated facility, as shown in FIG. 1), or at a hierarchically superior level 912 (e.g., a national level, as shown in FIG. 1). Each aggregated service facility (e.g., at any one of the hierarchical levels) may include the structure 910, which includes the EMR Webservice (804, 806, 808, respectively), the EMR Middle Tier (822, 824, 826, respectively), the EMR SyncService (828, 830, 832, respectively), and the EMR database (834, 836, 838, respectively), as discussed above.

Thus, example techniques discussed herein may provide a robust, reusable, scalable system that may provide distributed network access to electronic patient data that may be hosted at multiple medical facilities.

Patient privacy and patient confidentiality have been ongoing considerations in medical environments for many years. Thus, medical facility personnel may provide permission forms for patient review and signature before the patient's information is entered into an electronic medical information system, to ensure that a patient is informed of potential risks of electronically stored personal/private information such as a medical history or other personal identifying information. Further, authentication techniques may be included in order for medical facility personnel to enter or otherwise access patient information in the system 100. For example, a user identifier and password may be requested for any type of access to patient information. As another example, an authorized fingerprint or audio identification (e.g., via voice recognition) may be requested for the access. Additionally, access to networked elements of the system may be provided via secured connections (or hardwired connections), and firewalls may be provided to minimize risk of potential hacking into the system.

Further, medical facility personnel may provide permission forms for medical facility employees for review and signature before the employees' information is entered into an electronic medical information system, to ensure that employees are informed of potential risks of electronically stored personal/private information such as a medical history or other personal identifying information.

Implementations of the various techniques described herein may be implemented in digital electronic circuitry, or in computer hardware, firmware, software, or in combinations of them Implementations may implemented as a computer program product, i.e., a computer program tangibly embodied in an information carrier, e.g., in a machine usable or machine readable storage device (e.g., a magnetic or digital medium such as a Universal Serial Bus (USB) storage device, a tape, hard disk drive, compact disk, digital video disk (DVD), etc.) or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand alone program or as a module, component, subroutine, or other unit suitable for use in a computing environment. A computer program that might implement the techniques discussed above may be deployed to be executed on one computer or on multiple computers at one site or distributed across multiple sites and interconnected by a communication network.

Method steps may be performed by one or more programmable processors executing a computer program to perform functions by operating on input data and generating output. The one or more programmable processors may execute instructions in parallel, and/or may be arranged in a distributed configuration for distributed processing. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a distributed patient data retrieval engine that includes:
a request input engine configured to obtain a summary request sent from a network client for one or more location indications associated with one or more medical facility locations associated with storage of detail patient data associated with a patient, the summary request including a patient identifier associated with the patient;
an index matching engine configured to determine, via a data query processor, whether an index patient indicator associated with the patient identifier is included in an aggregation facility index associated with an aggregation facility repository that includes summary patient data associated with a plurality of medical facilities and a plurality of patients;
a summary retrieval engine configured to obtain summary patient data that summarizes medical events associated with the patient identifier, based on information included in the aggregation facility index, if the index matching engine determines that the index patient indicator associated with the patient identifier is included in the aggregation facility index;
a response interface engine configured to initiate transmission to the network client of a summary data response that includes the summary patient data and one or more location indications associated with one or more medical facility locations associated with storage of detail patient data associated with the summary patient data, if the index matching engine determines that the index patient indicator associated with the patient identifier is included in the aggregation facility index; and
a superior service interface engine configured to forward the summary request to a hierarchically superior facility aggregation service, if the index matching engine determines that the index patient indicator associated with the patient identifier is absent from the aggregation facility index.

2. The system of claim 1, wherein:
the one or more location indications associated with the one or more medical facility locations associated with storage of detail patient data associated with the summary patient data are obtained from the aggregation facility index.

3. The system 1, wherein:
the one or more location indications associated with the one or more medical facility locations associated with storage of the requested detail patient data associated with the summary patient data include one or more Internet addresses associated with the one or more medical facility locations.

4. The system of claim 1, wherein:
the superior service interface engine is configured to receive, from the hierarchically superior facility aggregation service, forwarded summary patient data that summarizes medical events associated with the patient, and one or more forwarded location indications associated with one or more medical facility locations associated with storage of detail patient data associated with the forwarded summary patient data, and
the response interface engine is configured to initiate transmission of the forwarded summary patient data and the forwarded location indications to the network client, in response to the summary request.

5. The system of claim 1, further comprising:
a synchronization event interface engine configured to receive the summary patient data that summarizes medical events associated with the patient via a patient data synchronization event associated with a hierarchically inferior facility service;
a facility repository update engine configured to initiate an update to the aggregation facility repository, based on the summary patient data received via the synchronization event; and
an index update engine configured to initiate an update to the aggregation facility index associated with the aggregation facility repository, based on the summary patient data received via the synchronization event.

6. The system of claim 5, wherein:
the superior service interface engine is configured to initiate a hierarchy synchronization event with the hierarchically superior facility aggregation service based on the summary patient data received via the patient data synchronization event.

7. The system of claim 1, wherein:
the superior service interface engine is configured to forward the summary request to the hierarchically superior facility aggregation service based on one of:
forwarding the summary request from a regional level hierarchical facility aggregation service to a provincial level hierarchical facility aggregation service,
forwarding the summary request from a provincial level hierarchical facility aggregation service to a national level hierarchical facility aggregation service,
forwarding the summary request from a regional level hierarchical facility aggregation service to a statewide level hierarchical facility aggregation service, or
forwarding the summary request from a statewide level hierarchical facility aggregation service to a national level hierarchical facility aggregation service.

8. A computer program product tangibly embodied on a computer-readable medium and including executable code that, when executed, is configured to cause at least one data processing apparatus to:
receive a client request for detail patient data associated with one or more patient records associated with a patient;
initiate transmission, via a client processor, of a summary request to a facility aggregation service for one or more location indications associated with one or more medical facility locations associated with storage of the requested detail patient data;
receive summary patient data that includes the one or more location indications, in response to the summary request;
initiate transmission of at least one data request for the detail patient data to at least one facility data service associated with at least one of the location indications;
receive the requested detail patient data from the at least one facility data service; and
initiate a display of the received detail patient data.

9. The computer program product of claim 8, wherein the executable code, when executed, is configured to cause the at least one data processing apparatus to:
initiate the display of the received detail patient data based on initiating the display of the received detail patient data by a browser client, based on a template format associated with the facility aggregation service.

10. The computer program product of claim 8, wherein the executable code, when executed, is configured to cause the at least one data processing apparatus to:
initiate the transmission of the summary request based on initiating transmission of the summary request to the facility aggregation service by a browser client.

11. The computer program product of claim 8, wherein:
the one or more location indications associated with the one or more medical facility locations associated with storage of the requested detail patient data include one or more Internet addresses associated with the one or more medical facility locations.

12. The computer program product of claim 8, wherein:
the summary request includes a patient identification associated with the patient, and one or more of:
an indication of an attribute associated with the requested detail patient data, an indication of a requested medical facility associated with the requested detail patient data, an indication of a date range associated with the requested detail patient data, an indication of a medical event associated with the requested detail patient data, an indication of a medical provider identification associated with the requested detail patient data, or an indication of a medical treatment associated with the requested detail patient data.

13. The computer program product of claim 8, wherein:
the summary request includes a patient identification associated with the patient; and
the received summary patient data includes one or more of:
an indication of a medical event associated with the patient identification, an indication of a date of associated with the patient identification, an indication of a medical facility associated with the patient identification, an indication of a history associated with the patient identification, an indication of a patient attribute associated with the patient identification, or an indication of a medical treatment associated with the patient identification.

14. The computer program product of 8, wherein:
the facility aggregation service includes a hierarchical facility aggregation service, and
wherein the executable code, when executed, is configured to cause the at least one data processing apparatus to:
initiate transmission of a second summary request to a second hierarchical facility aggregation service for one or more second location indications associated with one or more medical facility locations associated with storage of the requested detail patient data,
wherein the second facility aggregation service is hierarchically superior to the hierarchical facility aggregation service.

15. The computer program product of claim 8, wherein the executable code, when executed, is configured to cause the at least one data processing apparatus to:
initiate a display of the received summary patient data;
receive a first indication of a first user selection of a first portion of the summary patient data; and
determine a first selected location indication based on the first indication of the first user selection, wherein:
initiating transmission of the at least one data request for the detail patient data includes initiating transmission of the at least one data request for detail patient data associated with the first portion of the summary patient data to at least one facility data service associated with the first selected location indication.

16. The computer program product of claim 15, wherein the executable code, when executed, is configured to cause the at least one data processing apparatus to:
receive a second indication of a second user selection of a second portion of the summary patient data; and
determine a second selected location indication based on the second indication of the second user selection, wherein:
initiating transmission of the at least one data request for the detail patient data includes initiating transmission of the at least one data request for detail patient data associated with the second portion of the summary patient data to at least one facility data service associated with the second selected location indication.

17. The computer program product of claim 8, wherein:
the facility aggregation service includes one of a regional level hierarchical facility aggregation service, a statewide level hierarchical facility aggregation service, a provincial level hierarchical facility aggregation service, or a national level hierarchical facility aggregation service.

18. A computer program product tangibly embodied on a computer-readable medium and including executable code that, when executed, is configured to cause at least one data processing apparatus to:
obtain detail patient data associated with a patient, the detail patient data sent from a medical facility database interface;
obtain summary patient data that summarizes medical events associated with the patient, based on the detail patient data;
initiate, via a data management processor, a patient data synchronization event with a facility aggregation service based on the summary patient data;
receive a data request for the detail patient data, the data request associated with a network client requestor; and
initiate transmission of the detail patient data to the network client requestor.

19. The computer program product of claim 18, wherein the executable code, when executed, is configured to cause the at least one data processing apparatus to:
initiate an update request for updated detail patient data associated with the patient, the updated patient data stored in a medical facility database in a medical record format that is different from a format associated with the transmitted detail patient data.

20. The computer program product of claim 19, wherein the executable code, when executed, is configured to cause the at least one data processing apparatus to:
initiate the update request based on initiating the update request via an update interface configured to initiate communication with a data provisioning engine configured to obtain medical record information from the medical facility database and convert the medical record information to a second format that is compatible with the format associated with the transmitted detail patient data.
